(19) United States
(12) Patent Application Publication
(10) Pub. No.: US 2006/0154074 A1
(43) Pub. Date: Jul. 13, 2006

(54) Wiring pattern drawing formation method and circuit board manufactured by using the same

(75) Inventor: Takuya Miyashita, Tokyo (JP)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: Japan Aviation Electronics Industry Limited, Tokyo (JP)

(21) Appl. No.: 11/314,282

(22) Filed: Dec. 20, 2005

(30) Foreign Application Priority Data
Jan. 11, 2005 (JP) 2005-004273

(51) Int. Cl. C23C 26/00; B05D 5/00; B32B 17/10

(52) U.S. Cl. 428/409; 427/96.1; 427/258

(57) ABSTRACT

In a method of forming by drawing a wiring pattern on a board by drip feeding a liquid solution including an electrically conductive constituent, there is used, for the board, a board with elemental oxygen included in a surface of the board, the surface having a critical surface tension at 25° C. of less than 25 dyn/cm, and for the liquid solution, there is used a liquid solution having a surface tension which is greater than the aforementioned critical surface tension. With the method, it is possible to combine drawability and adherence.

### BACKGROUND OF THE INVENTION

This invention pertains to a method of forming by drawing a wiring pattern on a board by drip feeding a liquid solution including an electrically conductive constituent and pertains in particular to a drawing formation method combining drawability on the board and adherence of the residual solid matter after drawing. Further, a liquid solution is taken to be, in addition to a solution in a so-called liquid phase, a solution in a state in which particulates are dispersively mixed in a liquid, these combined being called a liquid solution.

Initially, an explanation will be given regarding conventional technology concerning adherence and drawability.

First, an explanation will be given regarding adherence. In the case that e.g. the adherence between a liquid solution and a substrate on which the liquid solution is drip fed is considered, adhesives can be cited as representative liquid solutions. In general, an adhesive has the role of being a medium on a substrate on which it is drip fed, the objective thereof being adhesive fixation. And then, in order to fix adhesively, it is considered common practice to treat the substrate hydrophilically and increase the wettability of the adhesive, enlarging the fixation work. That is to say that, basically, to expect adherence (adhesive fixation) of a liquid solution on a substrate, treatment processing like hydrophilizing the substrate surface is carried out in order to increase the wettability of the liquid solution drip fed on the substrate.

Next, an explanation will be given regarding drawability. Drawing (drawing a picture) is e.g. performed by using a dispenser or an inkjet apparatus having a drawing function constituted by being equipped with a Personal Computer and following a prior drawing layout. Drawability means being drawn (copied) on the substrate side in accordance with a prior drawing, the surface state of the substrate being an important factor. Generally, if the wettability of the substrate surface is high, the drip fed liquid solution wets and spreads out and drawing in conformity with the layout cannot be expected. Consequently, in order to further improve drawability, a treatment such as processing the substrate surface to be water repellent is generally carried out.

Moreover, when it comes to consumer inkjet substrates widely disseminated today, there are performed operations such as forming a receptive layer on the surface thereof, a distinction being made with the substrate given the treatment mentioned above. In other words, there results a structure in which the solvent of the drip fed liquid solution is absorbed in the receptive layer and solutes in stuff like pigments or dyes, or dispersed solid matter inside the liquid solution, are fixed, the result being as a consequence an improvement in drawability this way.

Incidentally, a composition intended to combine adherence and drawability is set out in Japanese Patent Application Laid Open No. 2002-249691 (issued on Sep. 6, 2002; below called Reference 1). In Reference 1, there is described, for a full-color electronic blackboard that can print with an inkjet, a method of setting the critical surface tension γ_{C} at 25° C. of a recording medium used for an electronic blackboard to be in the range of 25 to 50 dyn/cm, and, in order for the ink not to blur or be repelled and to set an appropriate dot diameter, setting the ink surface tension γ_{L} in the range 65 _{C}≦γ_{L}≦γ_{C}+5 dyn/cm, in particular with the objective of improving fixability.

When forming by drawing a wiring pattern (circuits) on a board, it is important to combine adherence and drawability on the board of the wiring pattern, and if either is missing, it constitutes an obstacle to the formation of the wiring pattern. As mentioned above, in order to increase adherence, treatment processing towards hydrophilizing the board surface must be carried out, but on the other hand, in order to improve drawability, treatment processing towards making the board surface water repellent must be carried out. I.e., in order to combine adherence and drawability, there is the problem that mutually contradictory treatment processing is required.

Moreover, as mentioned above, the inkjet substrate, in order to solve this kind of problem, becomes one which makes a receptive layer provided in the surface of the substrate absorb a solvent and which makes solutes and dispersed solid matter adhere, but if a receptive layer like this is e.g. provided in the formation of a wiring pattern on a board, it means that the solutes and dispersed solid matter forming the wiring pattern become fixed inside the receptive layer, in other words that it is not possible to form the wiring pattern on the board surface, so consequently, a composition in which a receptive layer like this is provided cannot be adopted for forming by drawing a wiring pattern on a board.

Further, in Reference 1, for the full-color electronic blackboard that can print with an inkjet, the method is characterized by setting the critical surface tension γ_{C} of the recording medium to be in the range of 25 to 50 dyn/cm, and the ink surface tension γ_{L} to be in the range γ_{C}≦γ_{L}≦γ_{C}+5 dyn/cm, but the problem is those ranges. In other words, in an industrial use of forming by drawing a wiring pattern on a board, it is optimal, as will be subsequently described, for the surface tension γ_{L} of the liquid solution to be 25 to 35 dyn/cm, which is different from the range described in Reference 1, so that in the case of forming by drawing a wiring pattern on a board, it has become clear that it is not possible to apply conditions such as those described in Reference 1 to the conditions for the critical surface tension γ_{C} of the board and the surface tension γ_{L} of the liquid solution.

### SUMMARY OF THE INVENTION

It is an object of this invention to provide an optimal drawing formation method combining drawability and adherence in the drawing formation of a wiring pattern on a board.

According to a first aspect of the invention, in a method of forming by drawing a wiring pattern on a board by drip feeding a liquid solution including an electrically conductive constituent, there is used, when it comes to the board, a board having elemental oxygen included in a surface of the board, the surface thereof having a critical surface tension at 25° C. of less than 25 dyn/cm, and, when it comes to the liquid solution, there is used a liquid solution, the surface tension of which is greater than the aforementioned critical surface tension.

According to a second aspect of the invention, in a method of forming by drawing a wiring pattern on a board by drip feeding a liquid solution including an electrically conductive constituent, there is used, when it comes to the board, a board having elemental oxygen and elemental silicon included in a surface of the board, the surface thereof having a critical surface tension at 25° C. below 25 dyn/cm, and, when it comes to the liquid solution, there is used a liquid solution, the surface tension of which is greater than the aforementioned critical surface tension.

According to a third aspect of the invention, in a method of forming by drawing a wiring pattern on a board by drip feeding a liquid solution including an electrically conductive constituent, a coating layer is formed on the board, the drawing being formed on the coating layer and the coating layer including elemental oxygen and elemental silicon, the critical surface tension thereof at 25° C. being chosen to be below 25 dyn/cm, and when it comes to the liquid solution, there is used a liquid solution, the surface tension of which is greater than the aforementioned critical surface tension.

According to this invention, in a method of forming by drawing a wiring pattern on a board, it is possible to combine drawability on the board and adherence of residual solid matter after the drawing, so it is possible to obtain drawing formation suitable for the manufacturing of circuit boards. In particular, the drawing formation method according to this invention is optimal for application to flexible circuit boards and the like provided in the interior of miniaturized portable equipment, etc., so it is possible to manufacture flexible circuit boards having minute wiring patterns like those in an excellent way.

### BRIEF DESCRIPTION OF THE DRAWING

FIG. 1 is a plan view showing a wiring pattern on which a drawing evaluation has been performed.

### DESCRIPTION OF THE PREFERRED EMBODIMENTS

As a drawing apparatus forming by drawing a wiring pattern on a board, one using a dispenser or an inkjet device with a drawing function included and equipped with a Personal Computer is considered, a generic version of these dispensers or inkjet devices etc. with a drawing function included being used, the results of drawing experiments for which are explained first.

Initially, an explanation will be given from the perspective of the liquid solution.

In the case of applying the invention to the industrial use of forming by drawing a wiring pattern on a board, for the solvent of the liquid solution, an organic type solvent, not of a general water type, suitable for homogeneously dissolving solutes or homogeneously dispersing solid matter composed of particulates, was found to be optimal. In particular, it was possible usually to stably draw by discharging, without clogging in minute nozzles, by using an organic type solvent having a low speed of evaporation. As optimal organic type solvents, diethylene glycol diethyl ether, diethylene glycol acetate, tetradecane, and the like, can e.g. be cited. The boiling points of these solvents were found to be on the order of 190° C. to 220° C.

As a reason why it was possible for liquid solutions including these organic solvents to discharge stably, it was recognized that it results, apart from the boiling points, from the surface tension of the solvents. Fundamentally, if the surface tension of the liquid solution discharged from the nozzle is high, a meniscus cannot be formed, and if it is low, droplets cannot be formed in the air at the instant of the discharge. In other words, it means that there exists an optimal surface tension for liquid solutions. The fact that, for water type solvents, the surface tension is on the order of 70 dyn/cm, which is too high, can be stated as a reason for the inability to discharge stably. According to the experiments, in the case of application to the industrial use of forming by drawing a wiring pattern on a board, there was obtained the measurement result that it is optimal for the liquid solution surface tension γ_{L} at 25° C. to be in the range of 25 to 35 dyn/cm.

In order to form by drawing a wiring pattern on a board by means of a liquid solution having a surface tension γ_{L} like this, it was recognized that drawing is not possible unless the critical surface tension γ_{C} of the board is made smaller than the surface tension γ_{L} of the liquid solution. It was confirmed that droplets drip fed on the board remained in place on the proper location of the board by making the critical surface tension γ_{C} of the board smaller than e.g. 25 dyn/cm.

Next, an explanation will be given regarding adherence. Materials for which the critical surface tension γ_{C} is lower than 25 dyn/cm are nearly limited to fluoroplastics represented by Teflon™, etc., having a fluorine-type functional group. Materials having a fluorine-type functional group like this are materials representative of having a water-repellent effect, so adherence can generally not be expected.

Accordingly, in order to solve the adherence problem, attention was mainly paid to the relationship between solutes and solid matter, of the liquid solution remaining on the board, and the board surface. In order to form by drawing a wiring pattern on the board by means of a dispenser or an inkjet apparatus etc. having a drawing function, there is a need to make the critical surface tension γ_{C} of the board smaller than the minimum surface tension 25 dyn/cm of the liquid solution, and, under these conditions, adherence was improved by performing treatment processing so that elemental oxygen is included in the board surface.

As a reason why adherence improved, it is conjectured that board surface functional groups having elemental oxygen, and solutes and solid matter remaining on the board surface, formed hydrogen bonds or chemical bonds. In case elemental oxygen is not present and only fluorine-type functional groups are present on the surface of the board, hydrogen bonding chemical bonding cannot be expected, and intermolecular forces only, weaker than the hydrogen bonds or chemical bonds, are not sufficient to operate between the board and the residual solid matter. That is to say that it is conjectured that this is the reason why it was not possible to obtain adherence, if there was no elemental oxygen in the surface of the board.

Further, in the residual solid matter participating in the adhesion, the grain diameter thereof is also an important factor. According to the experiment, there was adhesion when the grain size was in or below the submicron range and there was no adhesion when the grain size was on the order of a micron (equal to or greater than 1 μm). It is known that, through the activity of the surfaces of grains with a grain size in or below the submicron range, the grains exhibit the reaction of fusing together in the solvent evaporation process. In other words, it can be conjectured that the bonding reaction with the board has made progress at the time of this reaction of fusing together. Moreover, when the grain size reaches the order of a micron, the fusing reaction does not make progress. In this case, it is insufficient for the grains to disperse individually, so reactions with the board cannot be expected. In other words, when the grain size is at or greater than the order of a micron, it can be conjectured that adherence with the board cannot be obtained.

As a treatment of a board for improving adherence, it is an optimal technique to perform an oxygen plasma treatment or a UV irradiation treatment with respect to the board surface when elemental oxygen is not present on the board surface. However, within the scope of making the critical surface tension γ_{C} of the board less than 25 dyn/cm, the surface tension of the liquid solution, something which is a prerequisite for drawability, it becomes a mandatory condition to perform the aforementioned treatment.

Moreover, in the case where the critical surface tension γ_{C} of the board surface is greater, it is possible to reduce the critical surface tension γ_{C} to less than 25 dyn/cm by carrying out a fluorine-type gas plasma treatment.

By what is mentioned above, in the formation by drawing of a wiring pattern on the board, it becomes possible to combine drawability and adherence.

Below, an explanation will be given of a specific embodiment of drawing formation of a wiring pattern on a board.

For a drawing apparatus, a commercially available inkjet apparatus was used. The board on which drawing was carried out was chosen to be a board having pliability (a flexible board), and the constituent material thereof was chosen to be PET (Polyethylene Terephtalate). The solvent of the liquid solution was chosen to be diethylene glycol diethyl ether, and a liquid solution was chosen in which silver grains with a grain size in or below the submicron range are dispersed as the electrically conductive constituent.

(1) The surface tension γ_{L} of the liquid solution was obtained. For the measurement, an interfacial surface tension measurement apparatus manufactured by Kyowa Kaimen Kagaku, Inc., was used, and analysis was made with the Young-Laplace method. As a result, the surface tension γ_{L} of the liquid solution at 25° C. was found to be 25 dyn/cm.

(2) The critical surface tension γ_{C} of the board was obtained. For the measurement, a contact angle measurement apparatus manufactured by Kyowa Kaimen Kagaku, Inc., was used; three kinds of liquid, purified water, methylene iodide, and bromonaphthalene, were drip fed; and after measuring the contact angles, an analysis was made on the basis of the Kitazaki-Hata method. As a result, the critical surface tension γ_{C} of the board at 25° C. was found to be 44 dyn/cm. Here, in order to make the critical surface tension γ_{C} of the board smaller than the surface tension γ_{L} of 25 dyn/cm of the liquid solution in Section 1, a fluorine-type plasma treatment was carried out on the board surface. As a result, the critical surface tension γ_{C} of the board was found to be 19 dyn/cm.

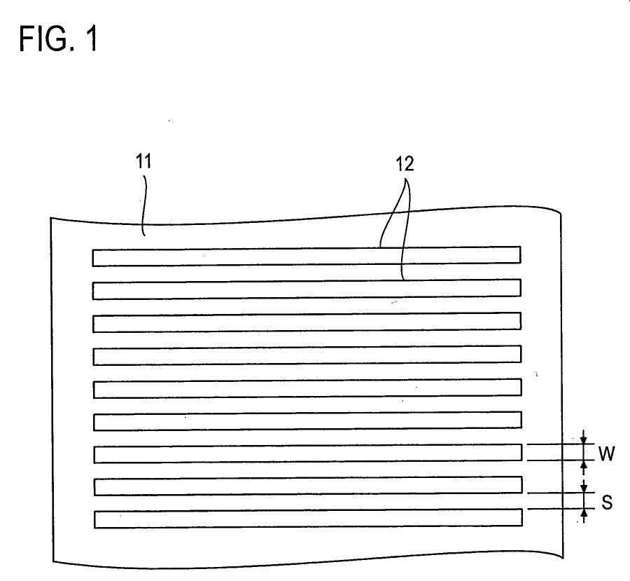

(3) Using the liquid solution and the board of Sections 1 and 2 above, drawing formation of a wiring pattern was performed by means of an inkjet apparatus. The inkjet apparatus was set to a resolution of 720 dpi and 40 pl/nozzle, and the drawing pattern on a board 11 was here chosen to be a line and space pattern like that shown in FIG. 1. Further, a pattern width W and a space S of a wiring pattern 12 were both chosen to be 0.1 mm, and the wiring length was chosen to be 25 mm.

(4) In order to promote the fusing together of the silver grains of the wiring pattern on board 11 on which a drawing has been formed, hardening was performed at 150° C. for 30 minutes.

(5) With respect to a circuit board formed as described above, an adherence test and a drawability evaluation were carried out. As the adherence test, a tape test (compliant with a standard of Japan Industrial Standards) was performed, and for the drawability evaluation, it was observed with a microscope whether short circuits between wiring pattern features and open circuits of the wiring pattern were present, and an electrical continuity test of the wiring pattern and an isolation test between wiring pattern features were also performed.

As a result, peeling did not occur in the adherence test, so the test was passed. Also, in the drawability evaluation, no abnormality was seen in an external appearance observation, and in the electrical continuity test of the wiring pattern, values on the order of 20 Ω were obtained, and further, in the test of isolation between wiring pattern features, values of 100 MΩ or more were obtained, so excellent results were obtained.

Next, as against the aforementioned embodiment, explanations regarding embodiments and comparative examples in which the board material and the liquid solution were changed and evaluated will be given.

The used liquid solutions are of three kinds, an organic silver liquid solution and a liquid solution in which silver grains with a grain diameter of 1 μm or more are dispersed, in addition to the aforementioned liquid solution. For board materials, in addition to PET, PE (polyethylene), PVDF (poly(vinylidene fluoride)), and Teflon™ were used. Adherence tests and drawability evaluations of the manufactured circuit boards were carried out, the evaluation/implementation modes complying with Sections 1 to 5 of the aforementioned embodiment. The results are shown in Table 1 below. Table 1 shows the results together with those of the aforementioned embodiment. Further, for the surface tensions γ_{L} at 25° C. of the used liquid solutions (the liquid solution with submicron-or-smaller dispersed silver grains, the organic silver liquid solution, and the liquid solution with 1-μm-or-larger silver grains) at 25° C., a measurement result of 25 dyn/cm was obtained for all three.

TABLE 1
Drawability and Adherence Evaluation Results

| | | | | | 1 μm-or- |
|---|---|---|---|---|---|
| | | | Submicron- | | larger |
| | | | or-smaller | | silver |
| | | (critical | silver grain | Organic | grain |
| | | surface | dispersion | silver | dispersion |
| | | tension | liquid | liquid | liquid |
| | Board + treatment | γ_{C}) | solution | solution | solution |
| γ_{C} ≧ γ_{L} | PET + coating | (45) | N & Y | N & Y | N & N |
| | PET | (44) | N & Y | N & Y | N & N |
| | PE | (31) | N & N | N & N | N & N |
| | PVDF | (25) | N & N | N & N | N & N |
| γ_{C} < γ_{L} | Teflon ™ | (20) | Y & N | Y & N | Y & N |
| | PET + | (19) | Y & Y | Y & Y | Y & N |
| | F-type plasma | | | | |
| | PET + coating + | (17) | Y & Y | Y & Y | Y & N |
| | F-type plasma | | | | |

* The table is a table which displays in sequence Y and N for the evaluation results of the drawability and the adherence, where Y indicates “good” and N indicates “bad”.
* The critical surface tension γ_{C} is the value measured at 25° C., the unit being dyn/cm.
* “Coating” indicates that a coating treatment was carried out on the board.
* “F-type plasma” indicates that a fluorine-type plasma treatment was carried out on the board.
* “Coating + F-type plasma” indicates that coating and F-type plasma treatments were carried out on the board.

For the coating treatment (“coating”) mentioned above, a silane (SiₙH₂ₙ+2) type coating material was used in this example, the coating layer being formed on the board by applying the silane-type coating material. By forming a coating layer like this, it is possible to make the inorganic solid matter of the liquid solution and the organic-material board adhere vigorously to one another. At the time of forming the coating layer on the board composed of PET, the critical surface tension γ_{C} of the surface of the coating layer worked out to 45 dyn/cm, but as a result of subsequently carrying out a fluorine-type plasma treatment, the critical surface tension γ_{C} worked out to 17 dyn/cm.

The surface chemical states of a board on which a coating layer treatment had been carried out and a board on which a fluorine-type plasma treatment had been carried out were analyzed with XPS (X-ray Photoelectron Spectroscopy). For the coating layer, it was confirmed that both elemental oxygen constituents and elemental silicon constituents were present, and in a state where fluorine-type plasma treatment had been carried out, it was confirmed that elemental fluorine constituents were present, in addition to elemental oxygen constituents and elemental silicon constituents.

From Table 1, the following can be stated.

1) For PET and PET with a coating treatment carried out, it is possible to respectively reduce substantially the critical surface tension γ_{C} (to 20 dyn/cm or less) by carrying out a fluorine-type plasma treatment.

2) With the condition that γ_{c}≧γ_{L}, drawability is bad, and by choosing γ_{C}<γ_{L}, excellent drawability is obtained.

3) With the condition that γ_{C}<Y_{L}, in case elemental oxygen is included in the board surface, excellent adherence is obtained.

4) Good adherence was obtained for both the submicron-or-smaller silver grain dispersion liquid solution and the organic silver liquid solution but was not obtained for the silver grain dispersion liquid solution with grain sizes of 1 μm or larger.

Further, in the examples mentioned above, an inkjet apparatus has been used as the drawing apparatus, but instead of this, a dispenser with a drawing function may be used.

What is claimed is:

1. A method of forming by drawing a wiring pattern on a board by drip feeding a liquid solution including an electrically conductive constituent, wherein
for said board, there is used a board which has elemental oxygen included in a surface of the board, said surface having a critical surface tension at 25° C. of less than 25 dyn/cm; and
for said liquid solution, there is used a liquid solution, the surface tension of which is greater than said critical surface tension.

2. A method of forming by drawing a wiring pattern on a board by drip feeding a liquid solution including an electrically conductive constituent, wherein
for said board, there is used a board which has elemental oxygen and elemental silicon included in a surface of the board, said surface having a critical surface tension at 25° C. of less than 25 dyn/cm; and
for said liquid solution, there is used a liquid solution, the surface tension of which is greater than said critical surface tension.

3. A method of forming by drawing a wiring pattern on a board by drip feeding a liquid solution including an electrically conductive constituent, wherein
a coating layer is formed on said board, the formation by drawing being carried out on said coating layer;
said coating layer has elemental oxygen and elemental silicon included, the surface thereof having a critical surface tension at 25° C. of less than 25 dyn/cm; and
for said liquid solution, there is used a liquid solution, the surface tension of which is greater than said critical surface tension.

4. A wiring pattern drawing formation method according to any of claims 1 to 3, wherein elemental fluorine is included in said surface.

5. A wiring pattern drawing formation method according to any of claims 1 to 3, wherein the surface tension at 25° C. of said liquid solution is equal to or greater than 25 dyn/cm and equal to or smaller than 35 dyn/cm.

6. A wiring pattern drawing formation method according to any of claims 1 to 3, wherein, for said liquid solution, there is used a liquid solution in which electrically conductive grains of sub-micron size or smaller are dispersed.

7. A wiring pattern drawing formation method according to any of claims 1 to 3, wherein, for said liquid solution drip feeding, a dispenser or an inkjet apparatus is used.

8. A circuit board characterized in that the wiring pattern is formed by using a wiring pattern drawing formation method according to any of claims 1 to 3.
